(19) United States
(12) Patent Application Publication
(10) Pub. No.: US 2019/0308641 A1
(43) Pub. Date: Oct. 10, 2019

(54) IMAGE CONTROL APPARATUS AND DISPLAY APPARATUS

(71) Applicant: NIPPON SEIKI CO., LTD., Niigata (JP)

(72) Inventor: Takumi SATO, Niigata (JP)

(21) Appl. No.: 16/315,455

(22) PCT Filed: Jul. 11, 2017
(86) PCT No.: PCT/JP2017/025191

§ 371 Date: Jan. 4, 2019

(30) Foreign Application Priority Data
Jul. 14, 2016 (JP) 2016-139594

(51) Int. Cl. B60W 50/14; B60R 16/02; B60K 35/00; G02B 27/01

(52) U.S. Cl. CPC B60W 50/14; B60R 16/02; G02B 2027/0181; G02B 27/0179; B60K 35/00

(57) ABSTRACT

A display apparatus is mounted in a vehicle controlled under driving modes including an autonomous driving mode. The display apparatus has a control means causing a display means to display, in response to receipt of a driving mode switching instruction, a progress image showing the progress to completion of switching of the driving mode by increases in an index amount. The control means increases the index amount of the progress image along a forward direction if the driving mode that would follow the switch is one in which there will be more operations under automatic control in the vehicle in comparison to before the switch. The control means increases the index amount of the progress image along the reverse direction if the driving mode that would follow the switch is one in which there will be less operations under automatic control in the vehicle in comparison to before the switch.

### TECHNICAL FIELD

The present invention relates to an image control apparatus and a display apparatus that are adapted to be mounted in a conveyance that can be controlled in plural driving modes including an autonomous driving mode.

### BACKGROUND ART

A vehicle driving assistance apparatus allowing a driver to be prepared in advance at the time of switching autonomous driving to manual driving is described in Patent Literature 1, as an apparatus adapted to be mounted in a conveyance that can be controlled in plural driving modes including an autonomous driving mode.

### CITATION LIST

### Patent Literature

Patent Literature 1: Japanese Unexamined Patent Application Publication No. 2015-230573

### SUMMARY OF THE INVENTION

### Problems to be Solved by the Invention

The technology described in Patent Literature 1 only predicts a cancellation of an autonomous driving mode, therefore having difficulties in allowing a driver to be noticed when the autonomous driving mode will be actually switched and suggesting to the driver an enough preparation for the driving mode switching.

The present invention is made in view of the circumstance described above. Accordingly, it is an object of the present invention to provide an image control apparatus and a display apparatus that allows a driver to understand the driving mode switching timing and easily get prepared for the driving mode switching.

### Solution to Problem

To achieve the above object, an image control apparatus according to a first aspect of the present invention is an image control apparatus adapted to be mounted in a conveyance that can be controlled in a plurality of driving modes including an autonomous driving mode. The image control apparatus includes a display control means configured to, in response to receipt of a driving mode switching instruction, control a display means to display a progress image indicating a progress to completion of the driving mode switching with an increase of an index amount. In a case where the number of targets for automatic control in the conveyance increases after the driving mode switching compared to before the driving mode switching, the display control means allows the index amount in the progress image to increase in a predetermined forward direction. In a case where the number of targets for automatic control in the conveyance decreases after the driving mode switching compared to before the driving mode switching, the display control means allows the index amount in the progress image to increase in an opposite direction of the forward direction.

To achieve the above object, the image control apparatus according to a second aspect of the present invention is an image control apparatus adapted to be mounted in a conveyance that can be controlled in a plurality of driving modes including an autonomous driving mode. The image control apparatus includes a display control means configured to, in response to receipt of a driving mode switching instruction, control a display means to display a progress image indicating a progress to completion of the driving mode switching with a decrease of an index amount. In a case where the number of targets for automatic control in the conveyance increases after the driving mode switching compared to before the driving mode switching, the display control means allows the index amount in the progress image to decrease in a predetermined forward direction. In a case where the number of targets for automatic control in the conveyance decreases after the driving mode switching compared to before the driving mode switching, the display control means allows the index amount in the progress image to decrease in an opposite direction of the forward direction.

To achieve the above object, the image control apparatus according to a third aspect of the present invention includes the display means and the image control apparatus. The display apparatus is configured to emit a display light from the display means to a translucent member and display an image by the display light forward of the translucent member.

### Effect of the Invention

According to the present invention, the driving mode switching timing can be understood and a driver can easily get prepared for the driving mode switching.

### BRIEF DESCRIPTION OF THE DRAWINGS

FIG. 1 is a block diagram of a vehicle display system according to an embodiment of the present invention.

FIG. 2 is a diagram illustrating a configuration where a display apparatus according to the embodiment of the present invention is mounted in a vehicle.

FIG. 3 is a diagram for explaining plural driving modes and route guide images respectively for the plural driving modes.

FIG. 4 is a flowchart of mode switching timing image control processing according to the embodiment of the present invention.

FIG. 5 is a diagram illustrating examples of image control when a manual driving mode is switched to a second autonomous driving mode.

FIG. 6 is a diagram illustrating examples of image control when a first autonomous driving mode is switched to the manual driving mode.

FIG. 7 is a diagram illustrating examples of suggestion images.

### MODE FOR CARRYING OUT THE INVENTION

A display apparatus according to an embodiment of the present invention will be described with reference to the drawings.

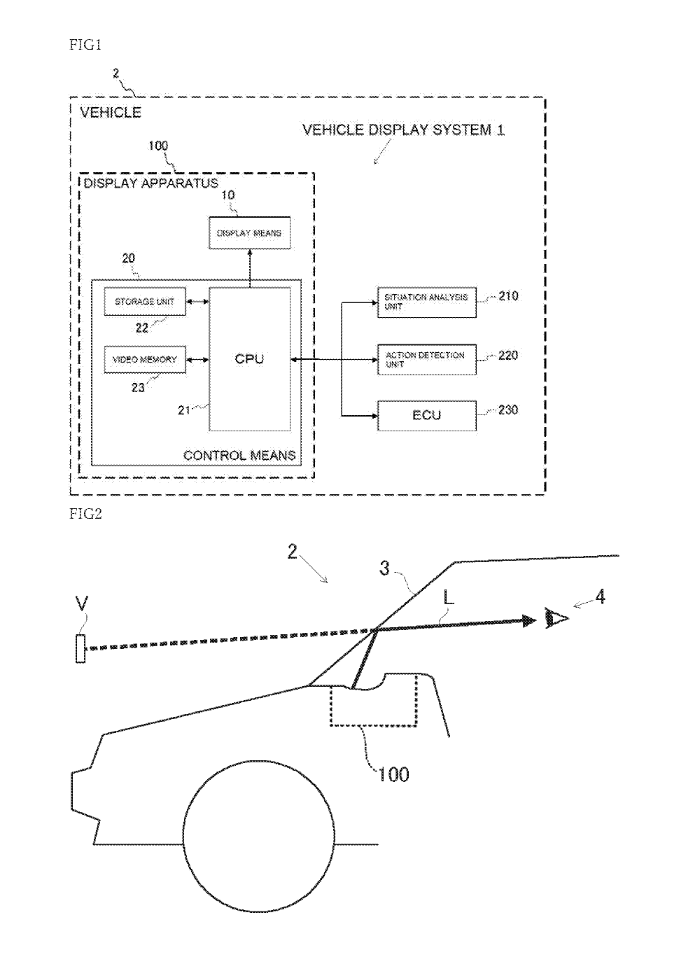

As illustrated in FIG. 1, a vehicle display system 1 according to the embodiment includes a display apparatus 100, a situation analysis unit 210, an action detection unit 220, and an ECU (Electronic Control Unit) 230.

(Display Apparatus 100)

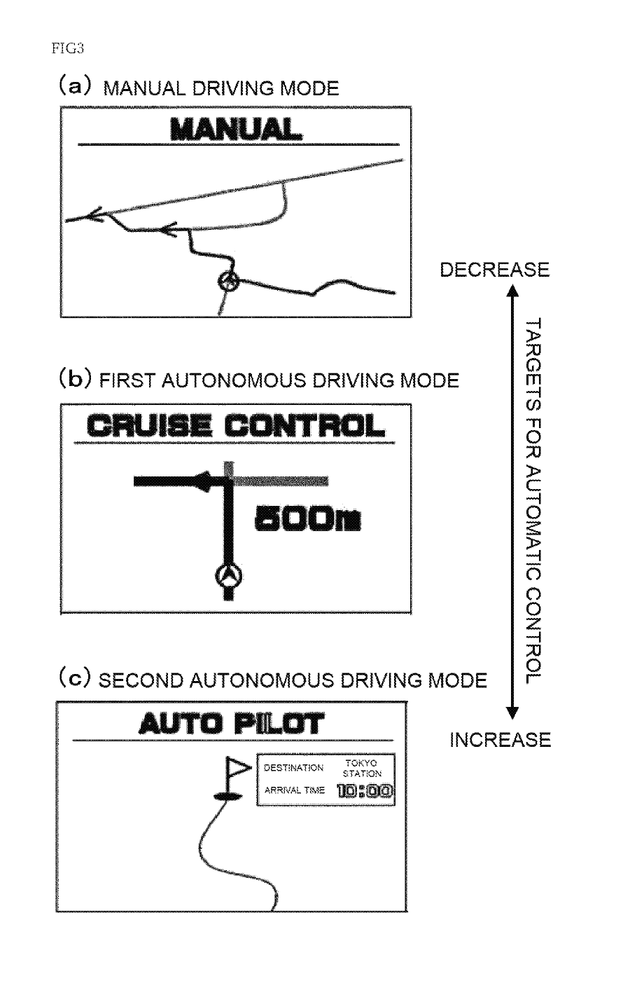

The display apparatus 100 is configured to communicate with respective units of the vehicle display system 1 and thereby, as illustrated in FIG. 2, displays various information (hereinafter, vehicle information) on a vehicle 2 to a driver 4 sitting in the vehicle 2. In addition, the vehicle information includes not only information on the vehicle 2 itself but also information on the outside of the vehicle 2.

The display apparatus 100 is configured to perform a specific image display control in plural driving modes (including an autonomous driving mode) set to the vehicle 2 when mode switching is made. “Autonomous driving” in this specification is not limited to complete autonomous driving and may include autonomous driving by which at least a portion of actions of the vehicle 2 such as acceleration and deceleration control, braking control, and steering control is automatically controlled.

As illustrated in FIG. 2, the display apparatus 100 is mounted in the vehicle 2 (the display apparatus is placed, for example, in an instrument panel of the vehicle 2). The display apparatus 100 is configured as a head-up display (HUD: Head-Up Display) structured to emit a display light L to a windshield 3 and display an image represented by the display light L as a virtual image V forward of the windshield 3. An image visually recognized as the virtual image V serves to give vehicle information. Thus, the driver 4 can visually recognize the vehicle information that is displayed while being overlapped with a scenery seen from the windshield 3.

As illustrated in FIG. 1, the display apparatus 100 includes a display means 10 and a control means 20.

The display means 10 is configured to display, under control of the control means 20, an image for giving the vehicle information. The display means 10 includes a liquid crystal display (LCD: Liquid Crystal Display), backing lights configured to illuminate the LCD from behind, and the like. The display means 10 may include an organic EL (Electro-Luminescence), a DMD (Digital Micromirror Device), reflective and transmissive LCOS. RTM (Liquid Crystal On Silicon), or the like.

In addition, the display apparatus 100 includes a reflector, not illustrated. The display light L representing an image displayed on the display means 10 is reflected by the reflector to be transmitted toward the windshield 3. The reflector includes two mirrors of a flat mirror and a concave mirror, for example. The flat mirror includes a cold mirror, for example, and is configured to reflect the display light L from the display means 10 on the concave mirror. The concave mirror is configured to expand the display light L that is emitted from the display means 10 and reflected by the flat mirror and to reflect the display light L on the windshield 3. Thus, the virtual image V visually recognized by the driver 4 is an expanded image displayed on the display means 10. Also, the reflector may include a single mirror or three or more mirrors.

The display light L is emitted from the display means 10 through the reflector described above as an example to the windshield 3. The display light L is reflected on the windshield 3 toward the driver 4 and thereby the virtual image V is displayed forward of the windshield 3 as seen from the driver 4.

The control means 20 serves to control an entire operation of the display apparatus 100, and as illustrated in FIG. 1, includes a CPU (Central Processing Unit) 21, a storage unit 22, a video memory 23, and a display control unit (graphic controller), not illustrated.

Also, the control means 20 is configured to communicate through an I/F (Interface) with the ECU 230, the situation analysis unit 210, and the action detection unit 220, for example, by CAN (Controller Area Network). A power source is connected to the display apparatus 100, and for example, when an ignition of the vehicle 2 is turned on, operation power is supplied to the control means 20. In addition, at least a portion of the control means 20 may include a dedicated circuit such as ASIC (Application Specific Integrated Circuit).

The storage unit 22 includes a ROM (Read Only Memory), a RAM (Random Access Memory), and the like. The ROM is configured to store in advance operation programs (programs for executing mode switching timing image control processing described below) or fixed data. The RAM is configured to temporarily store results of a variety of computation. For example, data indicating a discrimination result or a determination result in the mode switching timing image control processing described below is stored in the RAM.

The video memory 23 includes an HDD (Hard Disk Drive), a flash memory, and the like, and the video memory is configured to store data of images (image data) to be displayed on the display means 10.

The CPU 21 is configured to use the operation programs or the fixed data read out of the ROM of the storage unit 22 and to execute processing for controlling the entire operation of the display apparatus 100. At this time, a fixed data reading-out operation in which the CPU 21 reads out the fixed data from the ROM, a data writing-in operation in which the CPU 21 writes various types of data in the RAM of the storage unit 22 and temporarily stores the various types of data in the RAM, a data reading-out operation in which the CPU 21 reads out the various types of data temporarily stored in the RAM therefrom, a receiving operation in which the CPU 21 receives inputs of various signals through an I/F from the outside of the control means 20, a transferring operation in which the CPU 21 outputs various signals through an I/F to the outside of the control means 20, and other operations are performed. Further, the CPU 21 checks time as required with an integral timer.

Furthermore, the CPU 21 performs display control of the display means 10 by the display control unit in accordance with the image data stored in the video memory 23. The display control unit determines the content of control of a display operation in the display means 10 in accordance with a display control command from the CPU 21. For example, the display control unit determines the switching timing of images to be displayed on a display screen of the display means 10 and thereby controls various display operations to be performed. Additionally, the control means 20 has a layer assigned to each display content (an image to be visually recognized as a virtual image V including a progress image Q, an indication image R, a suggestion image T, or other notification images, which are described below).

(Situation Analysis Unit 210)

The situation analysis unit 210 is configured to function to: (i) output information required for notifying a route guide of the vehicle 1, to the control means 20; (ii) detect a preceding vehicle; and (iii) determine whether to cancel an autonomous driving mode (the autonomous driving mode will be described below).

The situation analysis unit 210 is configured to include, for example, a navigation system and a stereo camera configured to take an image ahead of the vehicle 2.

The navigation system includes a GPS controller configured to calculate a position of the vehicle 2 based on a GPS (Global Positioning System) signal received from artificial satellites. The navigation system including a storage unit for storing map data is configured to read out the map data of a location near the actual position from the storage unit in accordance with positional information from the GPS controller and to decide a guide route to a destination set by a user (mainly, the driver 4). Then, the navigation system outputs the actual position of the vehicle 2 or outputs information on the decided guide route to the control means 20. Additionally, the navigation system refers to the map data and thereby outputs information indicating the name and type of a facility ahead of the vehicle 2, a distance between the facility and the vehicle 2, or the like, to the control means 20. In the map data, various information, such as road shape information (lanes, road width, the number of lanes, crossroads, curves, forks, and the like), regulation information on road signs of a speed limit and the like, and if plural lanes are present, information on the respective lanes (which lane goes in which direction), is associated with the positional data. The situation analysis unit 210 outputs the various information (navigation information) to the control means 20.

Moreover, the situation analysis unit 210 performs image analysis by pattern matching method on data of front images (front image data) captured by the stereo camera and thereby detects various targets located forward of the vehicle 2 (hereinafter, also referred to as an own vehicle 2). Then, the situation analysis unit 210 outputs information on the detected various targets (herein, front information) to the ECU 230.

The front information includes information on an object (a preceding vehicle or an obstacle) on the road, road shape information (lanes, white lines, halt lines, crosswalks, road width, the number of lanes, crossroads, curves, forks, and the like), or other information. In addition, the situation analysis unit 210 is configured to calculate a distance between the own vehicle 2 and the object, an image of which is captured. The front information also includes the calculated distance.

Further, the situation analysis unit 210 may include a communication device configured to communicate with an outside server, an infrastructure, or the like. The situation analysis unit 210 communicates with the outside of the vehicle 2 and thereby may obtain at least a portion of the navigation information (including the road shape information, the regulation information, or the like) and the front information. Furthermore, the situation analysis unit 210 may include a sonar, an ultrasonic sensor, a millimeter-wave radar, and the like.

The situation analysis unit 210 determines based on the aforementioned road shape information or the front information, or action information from the action detection unit 220 whether it is necessary to cancel an autonomous driving mode. When having determined that it is necessary to cancel the autonomous driving mode, the situation analysis unit 210 outputs a “cancellation signal” to the ECU 230.

(Action Detection Unit 220)

The action detection unit 220 includes various sensors provided in the vehicle 2, a camera provided in the vehicle 2, and the like. The action detection unit 220 is configured to detect an action of the driver 4 and output information on the detected action to the ECU 230 or the control means 20. Actions to be detected by the action detection unit 220 are, for example, grabbing a steering wheel, operating the steering wheel, placing one's foot on an accelerator pedal or a brake pedal, operating the accelerator pedal or the brake pedal, turning one's eyes in a predetermined direction, turning one's eyes toward a predetermined position, pressing a predetermined switch or button, making a gesture, speaking a predetermined language, adjusting a seat, and the like.

Specifically, a “switching operation signal” based on a switching operation by the driver 4, a “preparation action detection signal” indicating a predetermined preparation action by the driver 4, or another signal is output from the action detection unit 220 to the ECU 230. The preparation action will be described below.

(ECU 230)

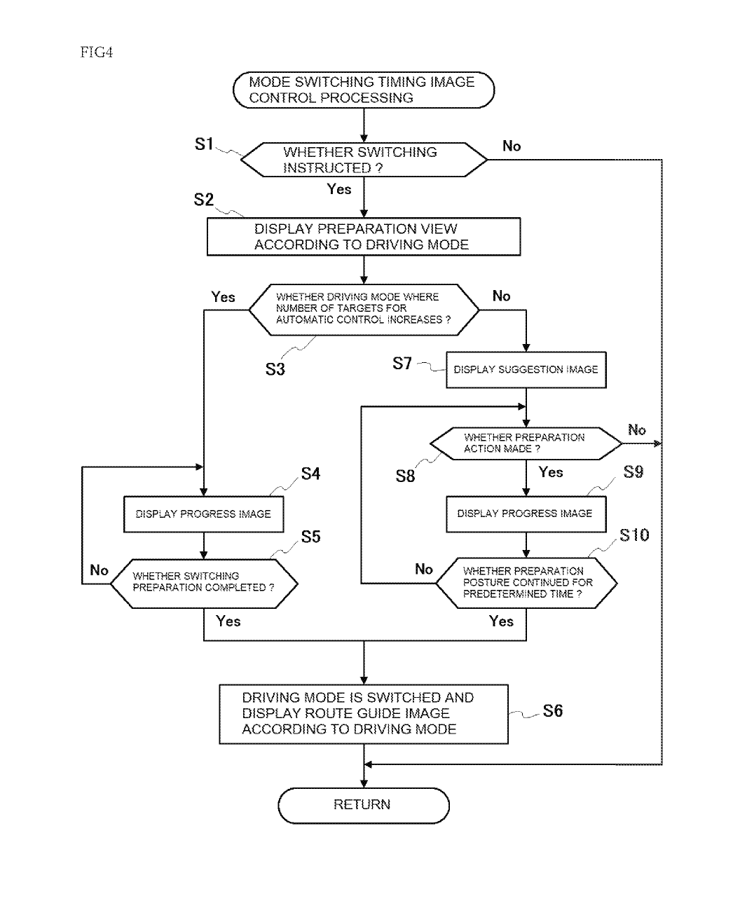

The ECU 230 is configured to control respective portions of the vehicle 2. In the embodiment, especially, the ECU 230 switches driving modes under a predetermined condition and thereby performs driving assist. In the embodiment, as illustrated in FIG. 3, three driving modes of a manual driving mode, a first autonomous driving mode, and a second autonomous driving mode are set in advance as the driving modes to the ECU 230.

The manual driving mode is a normal manual driving mode and is a mode, for example, when the ignition of the vehicle 2 is turned on. In the manual driving mode, a route guide image (an image visually recognized by the driver 4 as a virtual image V, and the same applies below) as illustrated in FIG. 3 (a) is displayed on the display means 10. At the time of the manual driving mode, the driver 4 needs to perform steering operations as required; therefore, among the driving modes prepared for the embodiment, a route guide image is displayed in the most detailed manner.

The first autonomous driving mode is a driving mode also referred to as a cruise control mode in which the ECU 230 automatically controls the vehicle 2 to accelerate and decelerate (steering is performed by the driver 4). In a condition where a speed or a preceding vehicle (following-target vehicle) is set by driving mode switching by the driver 4, another driving mode shifts to the first autonomous driving mode. In the first autonomous driving mode, a route guide image as illustrated in FIG. 3 (b) is displayed on the display means 10. At the time of the first autonomous driving mode, the vehicle 2 follows the preceding vehicle or runs at a constant speed. Therefore, for example, the route guide image is displayed in such a manner as to indicate the most recent lane change (right/left turn) (i.e., turn-by-turn display).

The second autonomous driving is a driving mode also referred to as autopilot in which not only acceleration and deceleration of the vehicle 2 but also steering of the vehicle 2 is controlled. When a speed or a preceding vehicle (following-target vehicle) is set in a condition where a destination is set by driving mode switching by the driver 4, another driving mode shifts to the second autonomous driving mode. In the second autonomous driving mode, a route guide image as illustrated in FIG. 3 (c) is displayed on the display means 10. At the time of the second autonomous driving mode, the vehicle 2 is automatically driven toward the set destination. Therefore, for example, the route guide image is displayed in such a manner as to indicate information on the set destination. That is, among the driving modes prepared for the embodiment, the second autonomous driving mode is configured such that the route guide image is displayed in the most schematic manner.

Here, focusing on targets for automatic control in the vehicle 2, the number of targets for automatic control increases in the order from the manual driving mode, the first autonomous driving mode, and the second autonomous driving mode. Also, focusing on route guide images, the manual driving mode is configured such that the route guide image is displayed in the most detailed manner, and the first autonomous driving mode is configured such that the route guide image is displayed schematically and the second autonomous driving mode is configured such that the route guide image is displayed more schematically.

Driving mode switching is executed (i) when a switching operation signal is transmitted from the action detection unit 220 in response to an operation by the driver 4 himself/herself and is received by the ECU 230 (that is, in accordance with an intention by the driver 4) or (ii) when a cancel signal from the situation analysis unit 210 is received by the ECU 230 (that is, not in accordance with an intention by the driver 4). Then, the ECU 230 receives the switching operation signal or the cancel signal and thereafter transmits a switching instruction command, which indicates a target driving mode, to the control means 20 of the display apparatus 100.

Additionally, in the embodiment, the target driving mode based on the switching operation signal may include a case where the number of targets for automatic control increases after the driving mode switching compared to before the driving mode switching and a case where the number of targets for automatic control decreases after the driving mode switching compared to before the driving mode switching. Meanwhile, the target driving mode based on the cancel signal may include only a case where the number of targets for automatic control decreases after the driving mode switching compared to before the driving mode switching. For example, when detecting an unexpected behavior of a preceding vehicle or when detecting that the vehicle 2 (herein, also referred to as the own vehicle 2) has got off the expressway, the situation analysis unit 210 outputs a cancel signal to the ECU 230. Further, the ECU 230 may determine whether it is necessary to cancel the autonomous driving mode.

Furthermore, the driving modes set to the ECU 230 may include plural driving modes as long as the driving modes set to the ECU 230 include at least an autonomous driving mode. Moreover, the type of autonomous driving mode is not limited to the aforementioned first autonomous driving mode or the aforementioned second autonomous driving mode. A target for automatic control (driving assist) may include at least a portion of types described below as examples. (1) Lane keeping assist (steering operation assist) for assisting steering and maintaining a relationship between the lane and the own vehicle 2, (2) Inter-vehicle distance control for controlling braking and driving forces of the own vehicle 2 and keeping a distance between a preceding vehicle and the own vehicle 2 constant or keeping the vehicle constantly to a set vehicle speed, (3) Parking assist for controlling steering and braking and driving forces of the own vehicle 2 and automatically parking the vehicle, (4) Lane change assist for controlling steering and braking and driving forces of the own vehicle 2 and automatically changing lanes, (5) Driving assist at merging and diverging sections for controlling steering and braking and driving forces of the own vehicle 2 at a merging or diverging section and allowing the own vehicle 2 to smoothly merge or diverge into a lane to be followed, (6) Right-left turn assist for when the own vehicle 2 is going to turn right or left at an intersection at a timing other than an appropriate timing, issuing an alert or controlling steering or braking and driving forces of the own vehicle 2 and allowing the own vehicle 2 to turn right or left appropriately, (7) Automatic start or stop assist for controlling braking and driving forces of the own vehicle 2 and allowing the own vehicle 2 to automatically start or stop, (8) Obstacle damage reduction/obstacle avoidance assist for when the own vehicle 2 is likely to collide with an obstacle in the traveling direction, issuing an alert or controlling steering or braking force of the own vehicle 2 and avoiding the own vehicle 2 from colliding with the obstacle, and other assists or controls.

Further, cancel operations may differ for each autonomous driving mode. Furthermore, a cancel operation may be unnecessary depending on items of autonomous driving mode driving assist. Moreover, plural operations are associated as cancel operations with a single autonomous driving mode. In such a case, at least one or more cancel operations of the plural cancel operations are performed and thereby the associated autonomous driving mode may be canceled.

In the mode switching timing image control processing to be described next, the control means 20 of the display apparatus 100 is configured to execute various image controls in response to receipt of a switching instruction command from the ECU 230.

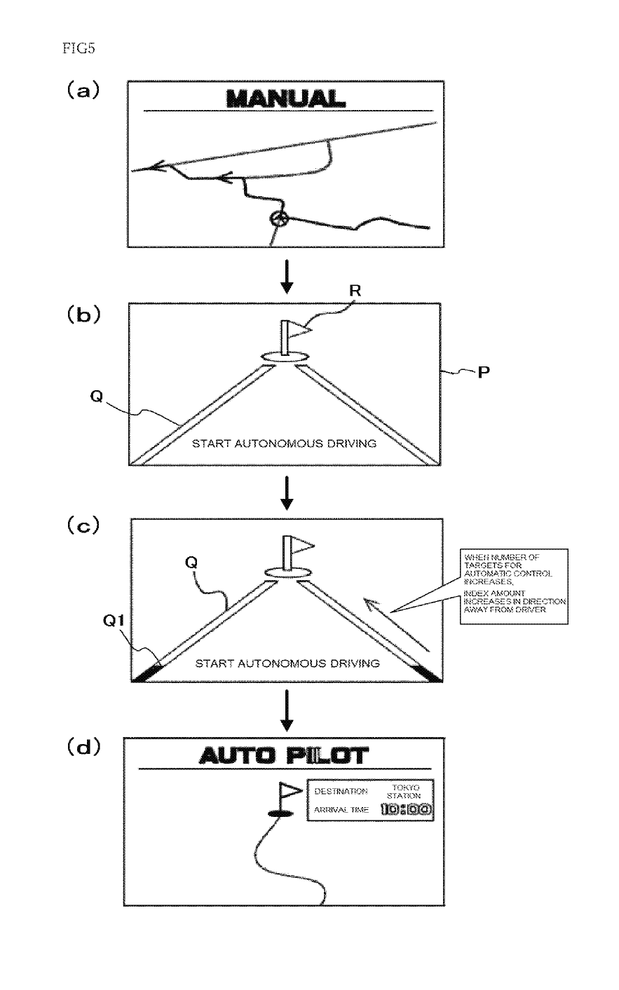

The display apparatus 100 configured as described above can display notification images other than the route guide images illustrated in FIG. 3 (a) to FIG. 3 (c). Hereinafter, the mode switching timing image control processing specific to the embodiment will be described with reference to FIG. 4 to FIG. 7. For example, when the supply of operation power to the display apparatus 100 is started in accordance with turning-on of the ignition of the vehicle 2, the CPU 21 activates. The mode switching timing image control processing is started in accordance with activation of the navigation system, for example. In addition, the display control unit, not illustrated, will not be referred to in the following processing in order to facilitate understanding of the explanation. The following processing may include control to be executed by the CPU 21 via the display control unit.

(Mode Switching Timing Image Control Processing)

First, the CPU 21 determines whether a driving mode switching instruction is issued (step S1). Specifically, when receiving the switching instruction command from the ECU 230, the CPU 21 determines that the switching instruction has been issued. In the processing of step S1, at a time immediately after the navigation system is activated, the route guide image illustrated in FIG. 3 (a) is displayed on the display means 10. Also, at a time after step S6 described below is executed, any one of the route guide images illustrated FIG. 3 (a) to FIG. 3 (c) is displayed on the display means 10.

When a driving mode switching instruction is issued (step S1; Yes), the CPU 21 instructs the display means 10 to display a preparation view P in accordance with the switching instruction (step S2). The preparation view P will be described below.

Next, the CPU 21 determines whether the number of targets for automatic control in a driving mode after the driving mode switching increases compared to before the driving mode switching (step S3).

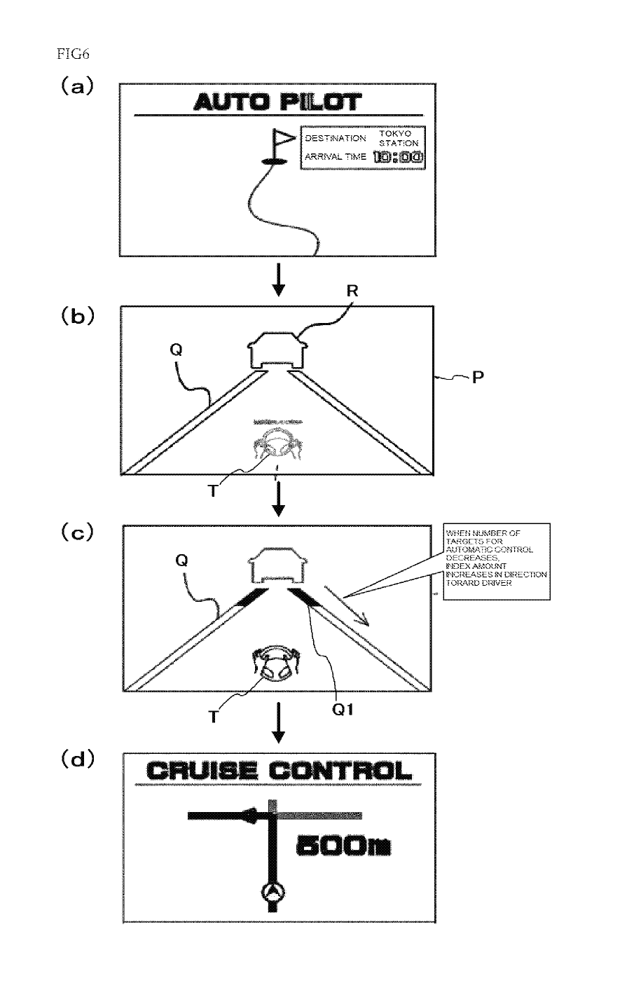

When the number of targets for automatic control in the driving mode after the driving mode switching increases compared to before the driving mode switching (step S3; Yes), the CPU 21 instructs the display means 10 to display a progress image Q (step S4). Herein, the processing in a case where Yes is determined in step S3 as just described will be described with reference to FIG. 5 (a) to FIG. 5 (d).

FIG. 5 (a) to FIG. 5 (d) illustrate examples of image control in a case where the manual driving mode is switched to the second autonomous driving mode. In this case, at the execution timing of step S1, a route guide image, illustrated in FIG. 5 (a), in the manual driving mode is displayed on the display means 10. Subsequently, when a switching instruction (here, the switching instruction to the second autonomous driving mode) is issued (step S1; Yes), the CPU 21 instructs the display means 10 to display a preparation view P as illustrated in FIG. 5 (b) (step S2).

In the examples of FIG. 5, switching from the manual driving mode to the second autonomous driving mode, that is, the case where the number of targets for automatic control increases, is illustrated. Accordingly, Yes is determined in step S3, and the CPU 21 allows the progress image Q, which indicates a progress to the driving mode switching, to be displayed in the preparation view P (step S4). The progress image Q is continuously displayed until a switching preparation is completed (step S5; No).

As illustrated in FIG. 5 (b) and FIG. 5 (c), the progress image Q is displayed with a bar graph that extends in a direction away from the driver 4 visually recognizing a display image by the display means 10 as a virtual image V. In the embodiment, the progress image Q is displayed in a manner to indicate the width of a travel lane. Specifically, the progress image Q is displayed, for example, along right and left white lines (white lines on the actual road) of the travel lane and with perspective in such a way that two bars extend away from the driver. In addition, the CPU 21 performs image control along with a progress to completion of the switching preparation such that an index amount Q1 increases in the progress image Q in a direction away from the driver 4 visually recognizing the virtual image V. Further, the CPU 21 can specify the switching preparation progress on the basis of information from the ECU 230. Furthermore, a period required for completion of the driving mode switching preparation in the vehicle 2 or in order to allow the driver 4 to afford to get prepared, a period longer than the period required for completion of the driving mode switching preparation, is established in advance as a period to completion of the driving mode switching preparation.

Also, in step S4, the CPU 21 allows the progress image Q to be displayed, and as illustrated in FIG. 5 (b) and FIG. 5 (c), the CPU 21 allows an indication image R, which indicates the driving mode after the driving mode switching, to be displayed at the increase side of the index amount Q1. The indication image R here is a “flag” icon image that schematically shows a destination to indicate a shift to the second autonomous driving mode in which the route guide image is displayed in a manner to give the information on the set destination.

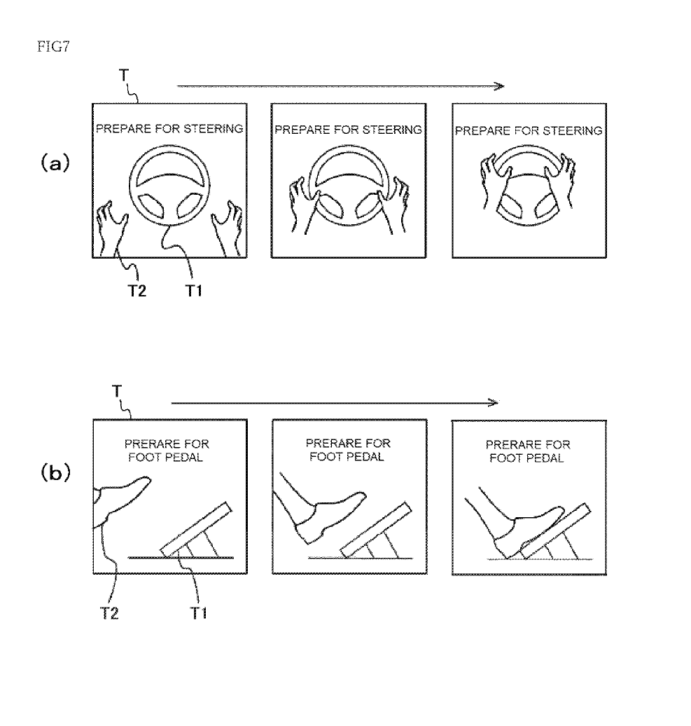

In addition, as long as the indication image R can indicate the driving mode after the driving mode switching, the indication image R is not limited to an icon. Alternatively, the indication image R may be represented literally or graphically or may be an image of a combination of letters and graphics (the same applies in FIG. 6 (b) or the like to be described).

When the driving mode switching preparation is completed (step S5; Yes), the driving mode switching is actually performed in the vehicle 2. In response to this switching, the CPU 21 instructs the display means 10 to display a route guide image (see FIG. 5(d)) in accordance with the corresponding driving mode (step S6). When the switching preparation is completed, the current driving mode is immediately switched to the subsequent driving mode in the vehicle 2 as just described. Thus, the progress image Q indicates the progress to completion of the driving mode switching.

Although not illustrated, likewise also at the switching timing from the manual driving mode to the first autonomous driving mode or at the switching timing from the first autonomous driving mode to the second autonomous driving mode, the index amount Q1 in the progress image Q is increased along with the progress to completion of the switching preparation in the direction away from the driver 4 visually recognizing the virtual image V. Thus, progress notification is performed.

In step S3, when the number of targets for automatic control in the driving mode after the driving mode switching decreases compared to before the driving mode switching (step S3; No), the CPU 21 instructs the display means 10 to display a suggestion image T (step S7). Herein, the processing in a case where No is determined in step S3 as just described will be described with reference to FIG. 6 (a) to FIG. 6 (d).

FIG. 6 (a) to FIG. 6 (d) illustrate examples of image control in a case where the second autonomous driving mode is switched to the first autonomous driving mode. In this case, at the execution timing of step S1, a route guide image, illustrated in FIG. 6 (a), in the second autonomous driving mode is displayed on the display means 10. Subsequently, when a switching instruction (here, the switching instruction to the manual driving mode) is issued (step S1; Yes), the CPU 21 instructs the display means 10 to display a preparation view P as illustrated in FIG. 6 (b) (step S2).

In the examples of FIG. 6, switching from the second autonomous driving mode to the first autonomous driving mode, that is, the case where the number of targets for automatic control decreases, is illustrated. Accordingly, No is determined in step S3, and the CPU 21 allows the suggestion image T to be displayed in the preparation view P (step S7).

The suggestion image T is displayed, as illustrated in FIG. 6 (b) and FIG. 6 (c), more specifically, as illustrated in FIG. 7 (a), in a manner to include an equipment image T1 of the vehicle 2 and a body image T2 mimicking the body of the driver 2.

In the example where the second autonomous driving mode is switched to the first autonomous driving mode, automatic control for steering is released after the driving mode switching. Therefore, the CPU 21 instructs the display means 10 to display the suggestion image T suggesting a preparation for steering. In this case, as illustrated in FIG. 7 (a), the equipment image T1 represents a steering wheel of the vehicle 2, and the body image T2 is an image mimicking the hands of the driver 4. Then, for example, until it is determined that a preparation action has been made in step S8 described below, an animation indicating a movement of the body image T2 toward the equipment image T1 is displayed as illustrated in FIG. 7 (a). Thus, the preparation for steering is suggested to the driver 4.

Also, in an example where the first autonomous driving mode is switched to the manual driving mode, automatic control for acceleration and deceleration is released after the driving mode switching. Therefore, the CPU 21 instructs the display means 10 to display a suggestion image T suggesting a preparation for operating a foot pedal (for example, an accelerator pedal, or a brake pedal is applicable in some cases). In this case, as illustrated in FIG. 7 (b), the equipment image T1 represents a foot pedal of the vehicle 2, and the body image T2 is an image mimicking the foot of the driver 4. Then, for example, until it is determined that a preparation action has been made in step S8 described below, an animation indicating a movement of the body image T2 toward the equipment image T1 is displayed as illustrated in FIG. 7 (b). Thus, a preparation for acceleration/deceleration is suggested to the driver 4. Also, in an example where the second autonomous driving mode is switched to the manual driving mode, the images illustrated in FIG. 7 (a) and FIG. 7 (b) may be simultaneously displayed.

Next, the CPU 21 determines whether a preparation action corresponding to the content of the suggestion image T is made (step S8). Specifically, it is determined whether a preparation action detection signal, which indicates that a preparation action is made within a predetermined time (for example, a few seconds), is obtained from the action detection unit 220 or the ECU 230. When a preparation action is not made within the predetermined time (step S8; No), the CPU 21 return the processing to step S1 so as to allow the driver 4 to be presumed unprepared. In this case, the present route guide image is returned back to the route guide image before the switching instruction.

When a preparation action is made within the predetermined time (step S8; Yes), the CPU 21 instructs the display means 10 to display a progress image Q indicating a progress to the drive mode switching (step S9). The progress image Q is continuously displayed until Yes is determined in step S10 described below.

As illustrated in FIG. 6 (b) and FIG. 6 (c), the progress image Q is displayed with a bar graph that extends in a direction away from the driver 4 visually recognizing a display image by the display means 10 as a virtual image V. The bar graph as just described is the same as the bar graph explained with reference to FIG. 5 (b) and FIG. 5 (c). It is to be understood that in a case where the number of targets for automatic control decreases after the driving mode switching, the CPU 21 performs image control along with a progress to completion of the switching preparation such that an index amount Q1 increases in the progress image Q in a direction toward the driver 4 visually recognizing the virtual image V.

Also, in step S9, the CPU 21 allows the progress image Q to be displayed, and as illustrated in FIG. 6 (b) and FIG. 6 (c), the CPU 21 allows an indication image R, which indicates a driving mode after the driving mode switching, to be displayed at the side away from the driver 4 visually recognizing the virtual image V. The indication image R here is an icon image that shows a traveling vehicle to indicate a shift to the first autonomous driving mode in which acceleration/deceleration control is performed.

Following step S9, the CPU 21 determines whether the driver 4 has maintained a preparation posture for a predetermine period (step S10). In a case where the number of targets for automatic control decreases after the driving mode switching compared with before the driving mode switching, the driver 4 needs to do some operations. Therefore, if a mode shift is completed immediately after the mode switching preparation is completed in the vehicle 2, the mode shift is not appropriate in view of safety. Consequently, in such a case, the processing described above is offered and thereby safety is secured. As a result, for example, a period equal to or longer than a period actually required for the switching preparation in the vehicle 2 is established in advance as the aforementioned predetermined period.

When the preparation posture has not been maintained for the predetermined period (step S10; No), the CPU 21 returns the processing to step S8. When determining in step S8 that no preparation action is made (step S8; No), the CPU 21 returns the processing to step S1. In this case, the present route guide image is returned back to the route guide image before the switching instruction. This is performed as described above in order to allow the driver 4 to be presumed unprepared.

On the other hand, when the preparation posture has been maintained for the predetermined period (step S10; Yes), the driving mode switching is actually performed in the vehicle 2. In response to this switching, the CPU 21 instructs the display means 10 to display a route guide image (see FIG. 6 (d)) in accordance with the corresponding driving mode (step S6).

Although not illustrated, likewise also at the switching timing from the second autonomous driving mode to the manual driving mode or at the switching timing from the first autonomous driving mode to the manual driving mode, the index amount Q1 in the progress image Q is increased along with the progress to completion of the switching preparation in the direction toward the driver 4 visually recognizing the virtual image V. Thus, progress notification is performed.

The CPU 21 repeatedly performs the mode switching timing image control processing described above, for example, until the navigation system is turned off.

In addition, a transition from the route guide image in the manual driving mode illustrated in FIG. 5 (a) to the preparation view P illustrated in FIG. 5 (b) is made such that a location near a destination indicated in the route guide image is gradually enlarged (zoomed in). Further, in a case where the route guide image illustrated in FIG. 5 (a) is not displayed in a head-up manner (for example, a north-up manner) such that the traveling direction of the vehicle 2 is directed upward, the transition to the preparation view illustrated in FIG. 5 (b) is made by zooming-up as described above and in addition, by rotation, therefore matching an actual sense of the driver 4 and appropriately providing a better visual effect.

Furthermore, a transition from the preparation view P illustrated in FIG. 5 (c) to the route guide image illustrated in FIG. 5 (d) is made by zooming-out. Specifically, for example, an icon indicating the destination illustrated in FIG. 5 (c) becomes gradually smaller; therefore, the transition to the route guide image illustrated in FIG. 5 (d) is made.

Likewise, the route guide image in the second autonomous driving mode illustrated in FIG. 6 (a) to the preparation view P illustrated in FIG. 6 (b) is made such that the route guide image is gradually enlarged (zoomed in). Specifically, a specific point (for example, a point corresponding to a current location of the vehicle 2) is enlarged and thereafter the transition to the preparation view P illustrated in FIG. 6 (b) is made.

Furthermore, a transition from the preparation view P illustrated in FIG. 6 (c) to the route guide image illustrated in FIG. 6 (d) is made by zooming-out. Specifically, an icon indicating a traveling vehicle illustrated in FIG. 6 (c) becomes gradually smaller; therefore, the transition to the route guide image illustrated in FIG. 6 (d) is made. Here, in a case where the traveling direction of the vehicle 2 is not display in a head-up manner (for example, a north-up manner) in a manner to be directed upward, the transition from FIG. 6 (c) to the route guide image illustrated in FIG. 6 (d) is made by zooming-out as described above and in addition, by rotation, therefore matching an actual sense of the driver 2 and appropriately providing a better visual effect.

(1) The display apparatus 100 described above includes an image control apparatus adapted to be mounted in the vehicle 2 that can be controlled in plural driving modes including an autonomous driving mode (the image control apparatus is configured to include the function of the control means 20, for example).

The image control apparatus includes a display control means (for example, the control means 20) configured to, in response to receipt of a driving mode switching instruction, control the display means 10 to display a progress image Q, which indicates a progress to completion of the driving mode switching, with an increase of an index amount Q1. In a case where the number of targets for automatic control in the vehicle 2 increases after the driving mode switching compared to before the driving mode switching, the display control means allows the index amount Q1 in the progress image Q to increase in a predetermined forward direction (for example, in a direction directed away from the driver 4. In a case where the number of targets for automatic control in the vehicle 2 decreases after the driving mode switching compared to before the driving mode switching, the display control means allows the index amount Q1 in the progress image Q to increase in an opposite direction of the forward direction (for example, in a direction directed toward the driver 4).

Thus, the driving mode switching timing can be understood and the driver 4 can easily get prepared for the driving mode switching.

In addition, the forward direction is not limited to the direction directed away from the driver 4 (the direction corresponding to the forward direction of the vehicle 2). The forward direction may be either the right or left or any direction when seen from the driver 4. However, when the forward direction is set as the forward direction of the vehicle 2, it is easier for the driver 4 to sensuously recognize the increase or decrease of targets for automatic control, which is preferably user-friendly.

(2) Also, in response to receipt of the switching instruction, the display control means displays an indication image R, which indicates a driving mode after the driving mode switching, at a position eccentrically located in the forward direction (see FIG. 5 (b) and FIG. 6 (b)) in a display area (corresponding to a display area of a virtual image V) of the display means 10.

Thus, since the indication image R is displayed at the position eccentrically located in a direction corresponding to the forward direction of the vehicle 2, a target driving mode can be easily recognized.

Further, for example, in a case where the number of targets for automatic control decreases, the indication image R may be displayed at a position eccentrically located in an opposite direction of the forward direction. That is, not only in a case where the number of targets for automatic control increases but also in a case where the number of targets for automatic control decreases, the indication image R may be displayed at the increase side of the index amount Q1.

Furthermore, the indication image R may represent a driving mode before the driving mode switching. In a case where in response to receipt of the switching instruction, the indication image R, which indicates a driving mode after the driving mode switching, is displayed at a position eccentrically located in the forward direction in the display area of the display means 10, the indication image R, which indicates a driving mode before the driving mode switching, is preferably displayed at a position eccentrically located in the opposite direction of the forward direction in the display area of the display means 10.

(3) Also, in response to receipt of the switching instruction, the display control means controls the display means 10 to display a suggestion image T suggesting to the driver 4 a preparation for a driving mode after the driving mode switching.

(4) More specifically, in a case where the number of targets for automatic control in the vehicle 2 decreases after the driving mode switching compared to before the driving mode switching, the display control means displays the suggestion image T.

Thus, safety can be secured at the time of the driving mode switching.

Also, in a case where the number of targets for automatic control in the vehicle 2 increases after the driving mode switching compared to before the driving mode switching, the display control means may display the suggestion image T.

(5) The suggestion image T includes an equipment image T1 of the vehicle 2 and a body image T2 mimicking the body of the driver 4 moving toward the equipment image T1.

Thus, the driver 4 can easily understand how he/she should act for preparation.

(6) The display control means controls the display means 10 to display a route guide image in accordance with types of the plurality of driving modes. In a case where the number of targets for automatic control in the vehicle 2 increases after the driving mode switching compared to before the driving mode switching, the route guide image is displayed in a schematic manner in a driving mode after the driving mode switching compared to before the driving mode switching. In a case where the number of targets for automatic control in the vehicle 2 decreases after the driving mode switching compared to before the driving mode switching, the route guide image is displayed in a detailed manner in a driving mode after the driving mode switching compared to before the driving mode switching.

Thus, the route guide image is displayed in accordance with the driving mode and thereby the current driving mode can be easily understood.

(7) According to a modified example, a progress to completion of the driving mode switching may be indicated by an index amount associated with the remaining time before the driving mode switching completion. In this case, display control may be performed such that the index amount in a progress image decreases as the driving mode switching nears completion.

That is, the image control apparatus according to such a modified example includes a display control means configured to, in response to receipt of a driving mode switching instruction, control a display means to display a progress image, which indicates the progress to completion of the driving mode switching, with a decrease of the index amount. In a case where the number of targets for automatic control in the vehicle 2 increases after the driving mode switching compared to before the driving mode switching, the display control means allows the index amount in the progress image to decrease in a predetermined forward direction. In a case where the number of targets for automatic control in the vehicle 2 decreases after the driving mode switching compared to before the driving mode switching, the display control means allows the index amount in the progress image to decrease in an opposite direction of the forward direction.

In such a modified example, the driving mode switching timing can be understood and the driver 4 can easily get prepared for the driving mode switching.

(8) Also, the display apparatus 100 described above includes the display means 10 and the image control apparatus, and the display apparatus 100 is configured to emit a display light L from the display means 10 to a translucent member (for example, the windshield 3) and display an image by the display light L forward of the translucent member.

In addition, the present invention is not limited by the foregoing embodiment, the modified example, and the drawings. Changes (including the elimination of elements) can be made as needed without changing the scope of the present invention.

A target to which the display light L is to be emitted is not limited to the windshield 3 and may be a combiner including a plate-shapes half mirror, a hologram element, and the like.

Further, the progress image Q is displayed with two bar graphs in a manner to indicate the width of a travel lane but is not limited thereto. The progress image Q may be displayed with a single bar graph along an up-down direction when seen from the driver 2. It is to be understood that the progress image Q is displayed with the two bar graphs in consideration of perspective as described above and thus is preferably displayed and more simply overlapped with an actual scenery. Furthermore, as long as the progress image Q is displayed such that the index amount increases or decreases in a predetermined direction, the progress image Q may be displayed in any manner in accordance with an image design or with ease of recognition by the driver 4.

In addition, a conveyance in which the display apparatus 100 or the vehicle display system 1 is adapted to be mounted is not limited to the vehicle 2 (and may include not only an automatic four-wheeled vehicle but also an automatic two-wheeled vehicle or the like). The conveyance may be a ship, an airplane, a jet-ski bike, a snowmobile, or the like other than vehicles.

The foregoing operation program is defined as a program stored in advance in the ROM of the storage unit 22. Alternatively, the operation program may be distributed or offered by a detachable storage medium. Also, the operation program may be downloaded from another device connected to the display apparatus 100. Moreover, the display apparatus 100 may be configured to exchange a variety of data with another device through electric communication network or the like and thereby may execute each processing according to the foregoing operation program.

As described above, the explanation of common knowledge of one skilled in the art is omitted as necessary to facilitate understanding of the present invention.

### INDUSTRIAL APPLICABILITY

The present invention is suitable for a vehicle display system configured to display vehicle information to a driver.

### DESCRIPTION OF REFERENCE NUMERALS

1 Vehicle display apparatus
2 Vehicle
3 Windshield
4 Driver
100 Display apparatus
10 Display means
L Display light
Virtual image
P Preparation view
Q Progress image
Q1 Index amount
R Indication image
T Suggestion image
T1 Equipment image
T2 Body image
20 Control means
21 CPU
22 Storage unit
23 Video memory
210 Situation analysis unit
220 Action detection unit
230 ECU

1. An image control apparatus adapted to be mounted in a conveyance that can be controlled in a plurality of driving modes including an autonomous driving mode, the image control apparatus comprising:
a display control means configured to, in response to receipt of a driving mode switching instruction, control a display means to display a progress image indicating a progress to completion of the driving mode switching with an increase of an index amount, wherein in a case where the number of targets for automatic control in the conveyance increases after the driving mode switching compared to before the driving mode switching, the display control means allows the index amount in the progress image to increase in a predetermined forward direction, and
in a case where the number of targets for automatic control in the conveyance decreases after the driving mode switching compared to before the driving mode switching, the display control means allows the index amount in the progress image to increase in an opposite direction of the forward direction.

2. The image control apparatus according to claim 1, wherein in response to receipt of the switching instruction, the display control means displays an indication image, which indicates a driving mode after the driving mode switching, at a position eccentrically located in the forward direction or in the opposite direction in a display area of the display means.

3. The image control apparatus according to claim 1, wherein in response to receipt of the switching instruction, the display control means controls the display means to display a suggestion image suggesting to a driver a preparation for a driving mode after the driving mode switching.

4. The image control apparatus according to claim 3, wherein in a case where the number of targets for automatic control in the conveyance decreases after the driving mode switching compared to before the driving mode switching, the display control means displays the suggestion image.

5. The image control apparatus according to claim 3, wherein the suggestion image includes an equipment image of the conveyance and a body image moving toward the equipment image.

6. The image control apparatus according to claim 1, wherein the display control means controls the display means to display a route guide image in accordance with types of the plurality of driving modes,
in a case where the number of targets for automatic control in the conveyance increases after the driving mode switching compared to before the driving mode switching, the route guide image is displayed in a schematic manner in a driving mode after the driving mode switching compared to before the driving mode switching, and
in a case where the number of targets for automatic control in the conveyance decreases after the driving mode switching compared to before the driving mode switching, the route guide image is displayed in a detailed manner in a driving mode after the driving mode switching compared to before the driving mode switching.

7. An image control apparatus adapted to be mounted in a conveyance that can be controlled in a plurality of driving modes including an autonomous driving mode, the image control apparatus comprising:
a display control means configured to, in response to receipt of a driving mode switching instruction, control a display means to display a progress image indicating a progress to completion of the driving mode switching with a decrease of an index amount, wherein in a case where the number of targets for automatic control in the conveyance increases after the driving mode switching compared to before the driving mode switching, the display control means allows the index amount in the progress image to decrease in a predetermined forward direction, and
in a case where the number of targets for automatic control in the conveyance decreases after the driving mode switching compared to before the driving mode switching, the display control means allows the index amount in the progress image to decrease in an opposite direction of the forward direction.

8. A display apparatus, comprising: the display means and the image control apparatus according to claim 1, the display apparatus being configured to emit a display light from the display means to a translucent member and display an image by the display light forward of the translucent member.
